(19) United States
(12) Patent Application Publication
(10) Pub. No.: US 2023/0166572 A1
(43) Pub. Date: Jun. 1, 2023

(54) Removably Engageable Slider Arms for Tow Truck for Lifting of Towed Vehicles

(71) Applicant: Austin Tryon, Bend, OR (US)

(72) Inventor: Austin Tryon, Bend, OR (US)

(21) Appl. No.: 18/073,447

(22) Filed: Dec. 1, 2022

Related U.S. Application Data
(60) Provisional application No. 63/285,045, filed on Dec. 1, 2021.

(51) Int. Cl. B60D 1/18; B60D 1/155

(52) U.S. Cl. CPC B60D 1/18; B60D 1/155

(57) ABSTRACT

An adjustable engagement system for a tow truck to operatively connect to a vehicle being towed provides slider arms which are removably engageable to conventional tow truck cross bars. The provided slider arms are removably positionable upon opposite ends of the conventional cross bar and adjustable thereon for spacing. Once such spacing is adjusted, locking members can be tightened to hold each slider arm in the chosen position for the towed vehicle.

This application claims priority to U.S. Provisional Patent Application 63/285,045 filed on Dec. 1, 2021, which is herein in its entirety by this reference thereto.

### BACKGROUND OF THE INVENTION

### 1. Field of the Invention

The invention herein disclosed relates generally to vehicles and towing thereof. More particularly, it relates to a wheel lift system which is removably engageable to a conventional towing crossbar to allow greater versatility to towing professionals and prevent damage to towed vehicles with low ground clearance.

### 2. Prior Art

### Background of the Invention:

Motor vehicles, such as cars and trucks, have become the primary mode of transportation of people and freight moving over the highways. For as long as motor vehicles have traversed the highways, there have been issues with vehicles becoming incapacitated and requiring a tow.

Motor vehicles, in decades past, were simple and generally had bodies for occupants and engines which were positioned atop vehicle frames. This construction generally provided significant ground clearance for both the motor and the body of the car or truck from the ground.

Modernly, with the advent of unibody construction, and the need for aerodynamic designs to minimize fuel use while maximizing mileage, ground clearance for both the body for the occupants and the engine, has decreased significantly.

Such decreased ground clearance presents a significant problem should the vehicle need towing. This is because the engine and other drive components, being closer to the ground, also position oil sumps, fluid reservoirs, axles and drive shafts in precarious positions when a vehicle needs towing. Conventional tow trucks employ a cross bar which is engaged with a receiver which is hydraulically powered on the truck. The receiver is powered both to lift and lower the cross bar and any vehicle engaged therewith.

In operation, the driver of the towing vehicle will back up toward the vehicle to be towed in a manner to position slider arms which are also wheel grids, slide bars, or receivers, to positions directly in front of both tires of the vehicle to be towed. The slider arms are positioned on a cross bar which, as noted, is engaged to a receiver on the truck. Once the slider arms are positioned in contact against the tires of the vehicle to be towed, the driver will position L-shaped lift arms where portions of the lift arms are positioned to the rear of the tires of the vehicle to be towed, and a front portion is engaged to the slider arm. Because the distance between the slider arm and the lift arms being less than the diameter of the tires of the car being towed, when the crossbar is elevated by the receiver, it will lift the two tires and the front of the car being towed.

However, as mentioned, on modern vehicles, with low ground clearance, it is an all to often occurrence where portions of the engine or body of the car being towed are damaged during the positioning of the slider arms under the body of the vehicle being towed and against the tires.

With respect to the above, before explaining at least one preferred embodiment of the removable engageable slider arms for towing herein, it is to be understood that the slider arm invention herein is not limited in its application to the details of employment and to the arrangement of steps set forth in the following description or illustrated in the drawings. The various apparatus components and methods and steps of the herein disclosed, are capable of other embodiments, and of being practiced and carried out in various ways, all of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based may readily be utilized as a basis for other tire identification, monitoring and warning systems. It is important, therefore, that the embodiments, objects and claims herein, be regarded as including such equivalent construction and methodology insofar as they do not depart from the spirit and scope of the present invention.

### SUMMARY OF THE INVENTION

The tow engagement system herein provides for slider arms which are removably engageable to conventional cross bars which are widely employed by tow trucks which tow disabled vehicles. The provided slider arms are operatively positionable upon opposite ends of the conventional cross bar by a sliding the cross bar into the passage of a mount of the device herein. Once spacing and positioning is adjusted by the user for towing the intended vehicle, locking members can be tightened to hold each slider arm in the chosen position.

Each slider arm has a spacing member engaged between the mount thereof and an angled contact which is positionable in contact with a front surface of a tire of a vehicle being towed. This spacing member is particularly preferred, in all modes of the device and system herein, in that it provides enhanced spacing between the mounts and the cross bar. This enhanced spacing, in experimentation, has proven to prevent damage from accidental contact with vehicle components underneath the vehicle and between the two wheels of the vehicle.

A minimum width D1 of the surface of this spacing member is preferably at least three inches and can be in a range between 3-12 inches to maintain the cross bar out of contact with vehicle components of vehicles with low ground clearance. Also, as shown in FIG. 1, a minimum distance D2 is preferred on each of the two slider arms, which will slide upon the tow bar to stops on each end of each tow bar. The provision of this minimum distance from the open end of the slider arm to the facing inside edges of the spacing members provides a manner in which to maintain a minimum gap or void between interior facing edges of the shown as D3. This is important in many cases to avoid contact of the inside edges of the two spacing members with portions of a vehicle.

Each slider arm also has a notch or void having a length D2 positioned between an opening at the end thereof which is slid upon the cross bar and the angled contact for the front of the wheels of the vehicle being towed. With each slider arm having a distance D2, which is currently preferred as 6-18 inches, and with each slider arm sliding upon the cross bar until it hits a stop or sidewall, a minimum void D3 is maintained between the inside edges of the two angled contacts for the tires which prevents contact of the slider arms or the cross bar onto which they engage from damaging contact with components of the vehicle being towed.

Each slider arm also has a strap winch positioned thereon substantially aligned with a central area of the angled contact to allow the user to cinch a strap to hold the tires of a vehicle being towed in position atop the angled contact and an L-bracket which is removably engageable to bracket mounts positioned on each slider arm.

With respect to the above summary description, before explaining at least one preferred embodiment of the removably engageable slider arms for towing herein, it is to be understood that the invention is not limited in its application to the details of operation nor the arrangement of the components or the steps set forth in the following description or illustrations in the drawings. The various methods of implementation and operation of the device herein, are capable of other embodiments and of being practiced and carried out in various ways which will be obvious to those skilled in the art upon their review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other modes for carrying out the several purposes of the present towing device. Therefore, that the objects and claims herein should be regarded as including such equivalent construction, steps, and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, the term “substantially” if not otherwise defined, means plus or minus five percent.

It is an object of this invention to provide improved slider arms for tow truck use, which will removably engage upon a conventional cross bar of a tow truck, thereby allowing the driver to easily change configurations of the tow truck for towing differing vehicles.

It is a further object of this invention to provide such slider arms which can be slidably positioned upon the tow truck cross bar and repositioned, as needed, for alignment with vehicles being towed.

It is a further object of this invention to provide slider arms for towing, which have a physical configuration which prevents contact of both the slider arms and the cross bar, with oil pans, engines, and body parts of a vehicle being towed, as the slider arms are being operatively positioned.

These together with other objects and advantages, which become subsequently apparent reside in the details of the construction and operation of the towing slider arms herein as more fully hereinafter described and claimed, reference being had to the accompanying drawings forming a part thereof, wherein like numerals refer to like parts throughout.

Further objectives of this invention may be ascertained by those skilled in the art as brought out in the following part of the specification wherein detailed description is for the purpose of fully disclosing the invention without placing any limitations thereon.

### BRIEF DESCRIPTION OF DRAWING FIGURE

The accompanying drawings, which are incorporated herein and form a part of the specification, illustrate some, but not the only or exclusive, examples of embodiments and/or features of the towing system and components herein. It is intended that the embodiments and figures disclosed herein are to be considered illustrative rather than limiting.

In the drawings:

FIG. 1 shows a perspective view of the two slider arms of the system herein operatively positioned in removable engagements on a conventional cross bar of a towing vehicle which is operatively engaged with a receiver on the towing vehicle, and the distances D1, D2, and D3 maintained by the components to protect the towed vehicle.

FIG. 2 shows a top view of the device of FIG. 1.

FIG. 3 depicts the slider arms herein in a disengaged configuration where they me operatively slid upon the cross bar as needed, or stored when other components are employed on the crossbar.

FIG. 4 shows a rear perspective view of the device of FIGS. 1-2.

FIG. 5 shows the conventional operation of the slider arm device herein, wherein it is first positioned upon the ground for engagement with tires of a vehicle, and is subsequently lifted to thereby lift the vehicle having tires engaged thereto.

FIG. 6 depicts a sectional view of the mount and spacing member herein.

FIG. 7 depicts a width-adjustable spacing member mode of the system herein.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right, first, second, and other such terms refer to the device as it is oriented and appears in the drawings and all such terms are used for convenience only and such are not intended to be limiting or to imply that the device and system has to be used or positioned in any particular orientation.

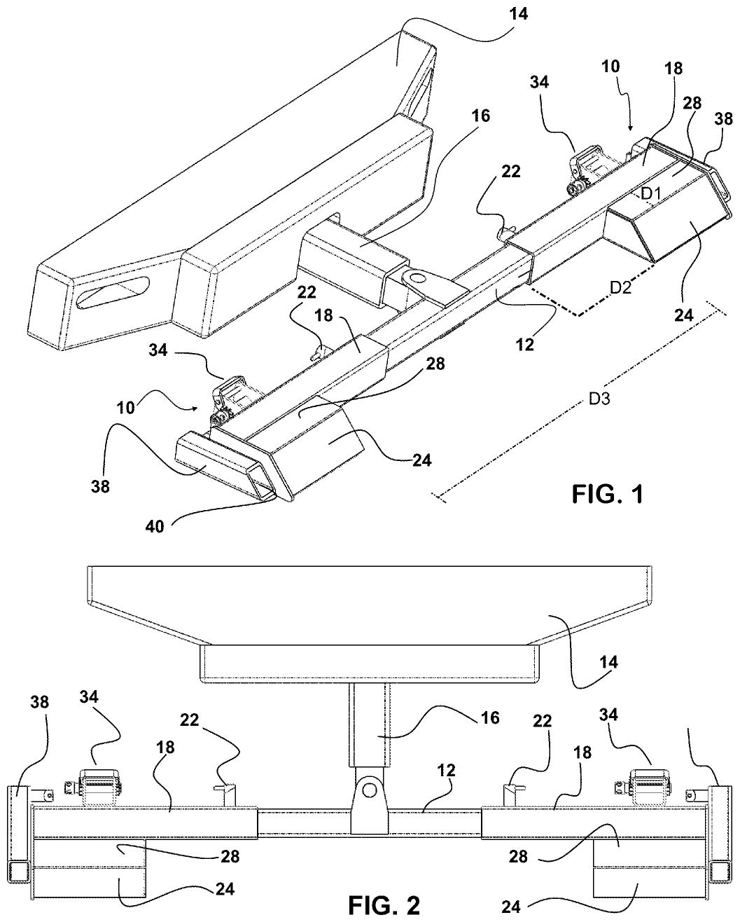

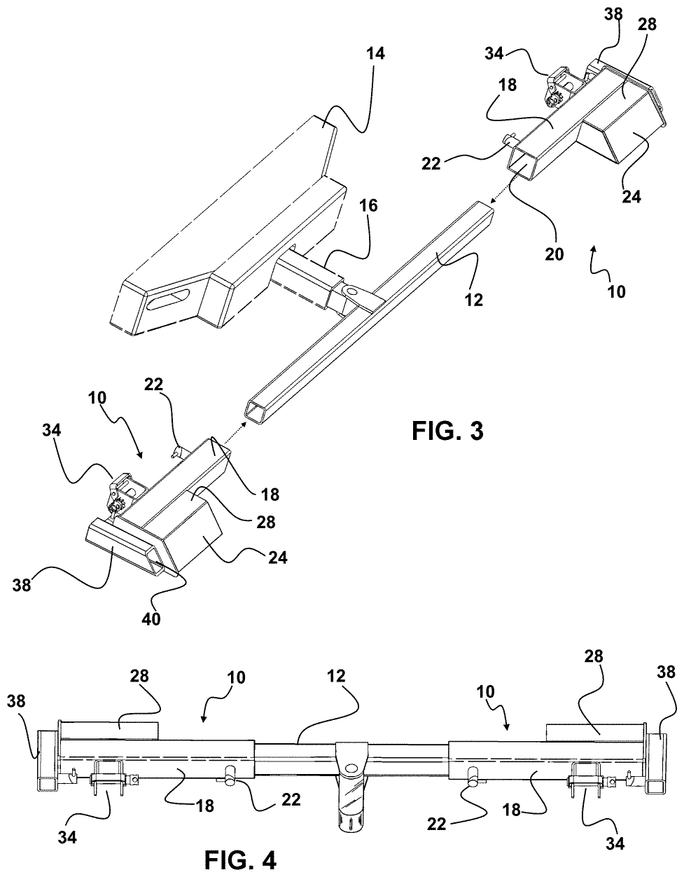

Now referring to drawings in FIGS. 1-7, wherein similar components are identified by like reference numerals, there is seen in FIGS. 1 and 2 a perspective view and overhead views of the two slider arms 10 of the system herein. As shown, the slider arms 10 are operatively positioned in removable engagements on opposite ends of a conventional cross bar 12 of a towing vehicle 14 which is operatively engaged with a receiver 16 on the towing vehicle 14. As noted, there are multiple terms for such slider arms 10 in the industry, such as wheel grids, slide bars, or receivers and the like, and the employment of the term slider arm 10 herein is for convenience and should in no fashion be considered limiting.

The slider arms 10 and the components forming them are preferably formed of metal, such as steel, due to the significant weight and forces exerted upon them during use. Each of the first and second slider arms 10 have a mount 18 which is positionable to operative engagement upon a conventional cross bar 12 used by tow trucks. Currently, such an operative engagement is best provided by a passage 20 communicating into one end of the respective mount 18. This passage 20 communicating into the mount 18 is sized with an interior perimeter surface and shape which substantially mirrors the exterior of the intended tow bar 12 and is substantially equal to or just slightly larger than the perimeter of the exterior surface of the tow bar 12 on which it engages. This provides for a sliding removable engagement upon a conventional towing cross bar 12 which is very secure and which prevents rotation of the mount 18 when so engaged.

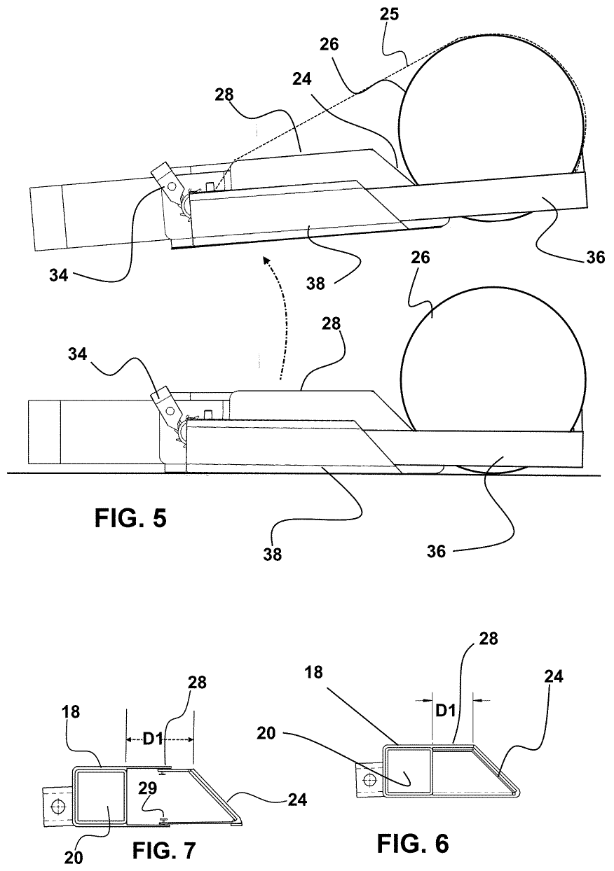

In use, the axial passage 20 of each mount 18 is aligned with a respective end of the cross bar 12 and thereafter slid upon the cross bar 12. Once the mount 18 is positioned within the passage 20, locking members 22, such as bolts, threadably engaged through a sidewall of each mount 18 may be tightened. The tightening of the locking members 22 removably holds the mounts 18, and thereby each of the respective slider arms 10, in fixed locations upon the cross bar 12. The locking members 22 providing the removable engagement to the cross bar 12 are preferred since the user may employ these locking members 22 and the sliding engagements of the mounts 18, to thereby position each respective slider arm 10, with a central area of an angled contact area 24 in substantial alignment with the center of tires 26 (FIG. 5) on a vehicle to be towed.

In all modes of the system, herein, a spacing member 28 is positioned between a top edge 30 of the angled contact area 24 for the tire and a rear edge 12 of the cross bar 12. The spacing member 28, preferably, has a width shown as distance “D1”, in FIGS. 1 and 6 and 7, of at least three inches and can vary between 3-12 inches. This spacing member 28 is particularly preferred to render both the cross bar 12 and the mounts 18 positionable further from each of the angled contacts 24 which are, during towing, positionable to respective contacts thereof against adjacent respective tires 26 of the vehicle being towed.

Additionally shown in FIG. 1 is distance D2 which is maintained between the open end having the passages 20 on each mount 18 and the side or sidewall of the spacing member 28. By maintaining this distance D2 a minimum distance and void D3 (FIG. 1) is maintained between the two slider arms 10 when they are positioned on the cross bar 12 as far as the cross bar 12 will slide into the passages 20 before they are stopped by the a stop such as an exterior sidewall of the spacing member 18. Currently, distance D2 is between 6-18 inches.

As noted, the system herein provides for the easy mount and dismount of the slider arms 10 from a conventional cross bar 12 to allow the user more versatility in towing. The slider arms 10, thus, can be removed and re-engaged, as needed, by sliding the passages 20 on each mount 18 onto or off of the cross bar 12, as needed. Additionally, the two slider arms 10 are adjustable for spacing from each other, in their respective positioning on the cross bar 12 to allow a user to substantially align each angled contact 24 with a respective wheel 26 of the vehicle to be towed.

Also provided are a strap winch 34 which is positioned on each mount 18 of each of the slider arms 10. The strap winch 34 is preferably substantially aligned with a central area of the angled contact 24 which is positioned on the opposite side of the mount 18 and the spacing member 28 from each respective strap winch 34. This strap winch 34 is employable to wind and cinch a securement strap 25 around the tire 26 of the vehicle being towed to hold it in a biased contact against the angled contact 24 and an L-bracket 36 (FIG. 5) which is positioned on the opposite side of the tire 26 from the angled contact 24. Each of the slider arms 10 has a bracket mount 36 engaged thereon with an axial cavity 40 which is configured to allow positioning of one end of such L-brackets 36 within the axial cavity 40 of the bracket mount 36.

In FIG. 5, as noted, is shown the conventional operation of the slider arm 10 device herein when operatively positioned upon a tow truck cross bar 12. As shown, with the surface of the angled contact 24 contacting with one side of a tire 26 of a vehicle to be towed, and the L-bracket adjusted in the axial passage 40 to be in contact with the opposite side of that tire 26, the tire 26 is supported on two opposing sides for lifting.

The strap 25 as shown for example in FIG. 5, may be cinched tight over the top surface of the tire 26 by operation of the strap winch 34. Once both tires 26 of a vehicle to be towed are so positioned and secured, the receiver 16 on the towing vehicle 14 is elevated which elevates the cross bar 12 and both of the slider arms 10, herein, along with the vehicle being towed. Of note, such a lifting is conventionally slightly in an arc, and the configuration of the slider arms 10 herein with the spacing member 28 helps prevent damage to the components of the vehicle between the two tires 26, for example the radiator or oil pan, which such a lifting along an arc may cause.

Shown in FIG. 7, in an adjustable mode of the spacing member 28 wherein the distance D1 can be adjusted by sliding one end of the spacing member outward in a direction away from the mount 18 in a telescopic fashion with a locking connector 29 which may be tightened or engaged to hold it in a chosen position and a chosen distance D1. This allows the user to change the distance of the spacing member 28 where more space is needed.

While all of the fundamental characteristics and features of the removably engageable slider arms which are configured for preventing towed vehicle damage, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth.

Further, while all of the fundamental characteristics and features of the towing invention have been shown and described herein, with reference to particular embodiments thereof, a latitude of modification, various changes and substitutions are intended in the foregoing disclosure as well as the claims which follow, and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are anticipated within the scope of the invention as defined by the following claims.

What is claimed is:

1. A system employing removably engageable slider arms which are configured for prevention of damage to underside components of a vehicle being towed, as shown and described herein.
